(19) United States
(12) Patent Application Publication
(10) Pub. No.: US 2015/0010015 A1
(43) Pub. Date: Jan. 8, 2015

(54) METHODS AND APPARATUS FOR SHARING A SERVICE BETWEEN MULTIPLE PHYSICAL MACHINES

(71) Applicant: General Dynamics, C4 Systems, Inc., Scottsdale, AZ (US)

(72) Inventors: Philip Geoffrey Derrin, Carlingford (AU); Carl van Schaik, Kingsford (AU); Ryan Peter Kingsley Mallon, Waterloo (AU); Adam Gordon Wiggins, Newtown (AU); Daniel Paul Potts, Botany (AU)

(21) Appl. No.: 13/935,914

(22) Filed: Jul. 5, 2013

(51) Int. Cl. H04L 12/911

(52) U.S. Cl. CPC H04L 47/781
USPC 370/462

(57) ABSTRACT

Methods and apparatus for sharing a physical device and/or service between multiple virtual and/or physical machines are disclosed. In an embodiment, a hypervisor grants permission to a first virtual machine to access a physical device via the hypervisor. For example, the hypervisor may grant permission to a first virtual machine to access a physical audio device. A second virtual machine then accesses the physical device via the hypervisor and the first virtual machine using a virtual services network stack. For example, the second virtual machine may play music on the audio device via the first virtual machine. In another embodiment, a first physical machine is granted permission to access and/or is connected to a physical device (e.g., an audio device) via a communication channel. A second physical machine then accesses the physical device (e.g., plays music) via the communication channel and the first physical machine using the virtual services network stack.

The present disclosure relates in general to sharing access to a service, and, in particular, to methods and apparatus for sharing a service between multiple physical machines.

### BACKGROUND

Often, a physical device and/or service is primarily controlled by one physical machine. For example, a display on a wireless phone or a vehicle user interface system may be controlled by one physical machine. However, other physical machines may need to access the physical device. For example, another physical machine may need to put something on the display. In order to accomplish this, an ad hoc protocol for communication between the primary physical machine and the other physical machines is typically created. However, a different protocol must be developed and implemented for each new device type (e.g., one for video devices, another for audio devices, etc.). Developing and implementing a new protocol for each new device type is time consuming and error prone.

### BRIEF DESCRIPTION OF THE DRAWINGS

FIG. 1 is a block diagram of an example network communication system.

FIG. 2 is a block diagram of an example electronic device.

FIG. 3 is a block diagram of another example electronic device.

FIG. 4 is a block diagram of another example electronic device, wherein two virtual machines are logically connected via a hypervisor.

FIG. 5 is a block diagram of two example electronic devices connected via a communication channel.

FIG. 6 is another block diagram of the example electronic device illustrated in FIG. 4.

FIG. 7 is another block diagram of the two example physical machines 102 illustrated in FIG. 5.

FIGS. 8-9 are a flowchart of an example process for sharing a physical device between multiple virtual machines.

FIGS. 10-11 are a flowchart of an example process for sharing a physical device between multiple physical machines.

FIG. 12 is a flowchart of another example process for sharing a physical device between multiple virtual machines.

FIG. 13 is a flowchart of another example process for sharing a physical device between multiple physical machines.

FIG. 14 is an example virtual service stack showing one end of a virtual services session with one core service and three other services.

### DETAILED DESCRIPTION OF THE PREFERRED EMBODIMENTS

Briefly, methods and apparatus for sharing a physical device between multiple virtual and/or physical machines are disclosed. In an embodiment, a hypervisor grants permission to a first virtual machine to access a physical device via the hypervisor. For example, the hypervisor may grant permission to a first virtual machine to access a physical audio device. A second virtual machine then accesses the physical device via the hypervisor and the first virtual machine using a virtual services network stack. For example, the second virtual machine may play music on the audio device via the first virtual machine. In another embodiment, a first physical machine is granted permission to access and/or is connected to a physical device (e.g., an audio device) via a communication channel. A second physical machine then accesses the physical device (e.g., plays music) via the communication channel and the first physical machine using the virtual services network stack.

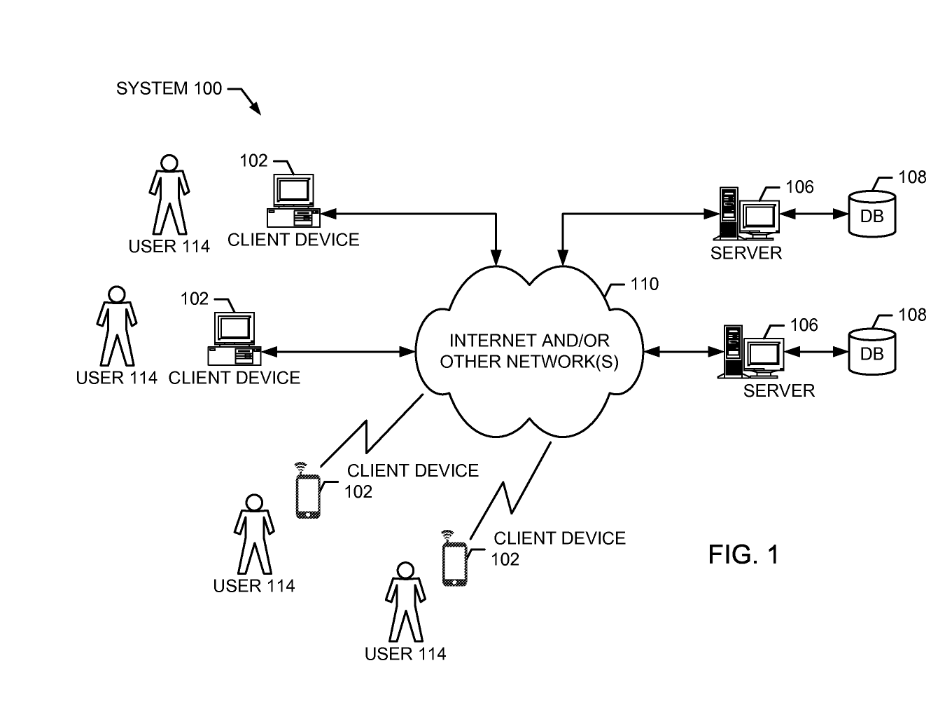

The present system may be used in a network communications system. A block diagram of certain elements of an example network communications system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, fewer low power microprocessors, and a single network connection.

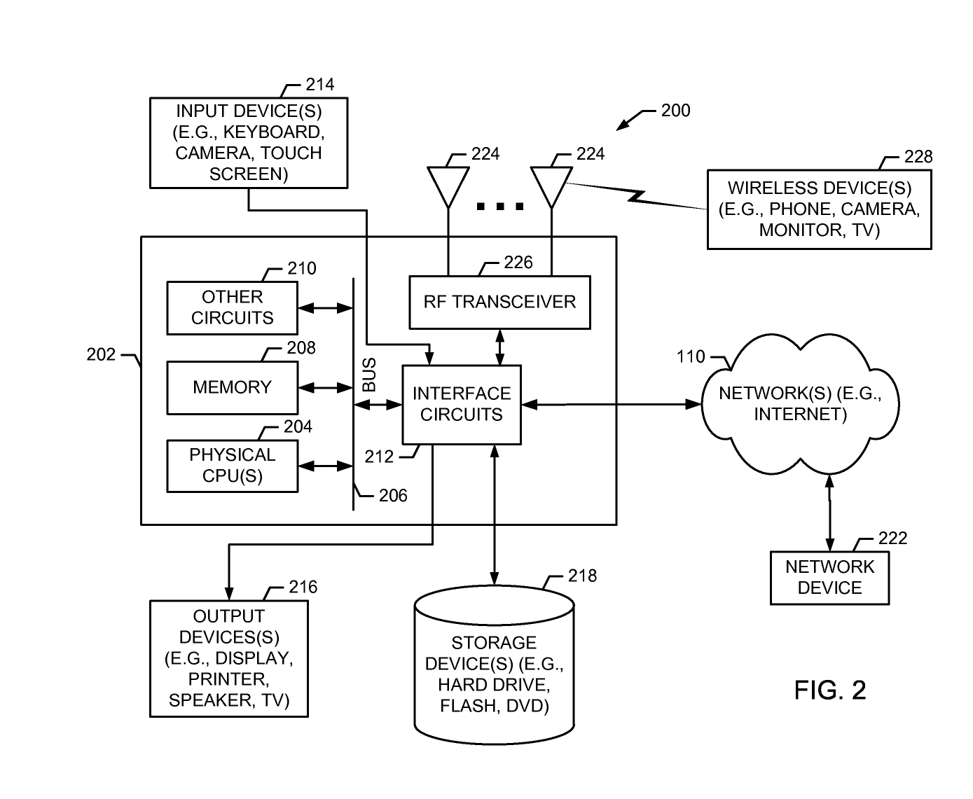

Each of the devices illustrated in FIG. 1 may include certain common aspects of many electronic devices such as microprocessors, memories, peripherals, etc. A block diagram of certain elements of an example electronic device 200 that may be used to capture, store, and/or playback digital video is illustrated in FIG. 2. For example, the electrical device 200 may be a client, a server, a camera, a phone, and/or a television.

The example electrical device 200 includes a main unit 202 which may include, if desired, one or more physical processors 204 electrically coupled by an address/data bus 206 to one or more memories 208, other computer circuitry 210, and one or more interface circuits 212. The processor 204 may be any suitable processor or plurality of processors. For example, the electrical device 200 may include a central processing unit (CPU) and/or a graphics processing unit (GPU). The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processor 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, camera and/or a voice recognition system.

One or more displays, printers, speakers, monitors, televisions, high definition televisions, and/or other suitable output devices 216 may also be connected to the main unit 202 via the interface circuit 212. The display 216 may be a cathode ray tube (CRTs), liquid crystal displays (LCDs), or any other type of suitable display. The display 216 generates visual displays of data generated during operation of the device 200. For example, the display 216 may be used to display web pages and/or other content received from a server. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200.

The electrical device 200 may also exchange data with other network devices 222 via a connection to a network. The network connection may be any type of network connection, such as an Ethernet connection, digital subscriber line (DSL), telephone line, coaxial cable, etc. Users of the system may be required to register with a server. In such an instance, each user may choose a user identifier (e.g., e-mail address) and a password which may be required for the activation of services. The user identifier and password may be passed across the network using encryption built into the user's browser. Alternatively, the user identifier and/or password may be assigned by the server.

In some embodiments, the device 200 may be a wireless device. In such an instance, the device 200 may include one or more antennas 224 connected to one or more radio frequency (RF) transceivers 226. The transceiver 226 may include one or more receivers and one or more transmitters. For example, the transceiver 226 may be a cellular transceiver. The transceiver 226 allows the device 200 to exchange signals, such as voice, video and data, with other wireless devices 228, such as a phone, camera, monitor, television, and/or high definition television. For example, the device may send and receive wireless telephone signals, text messages, audio signals and/or video signals.

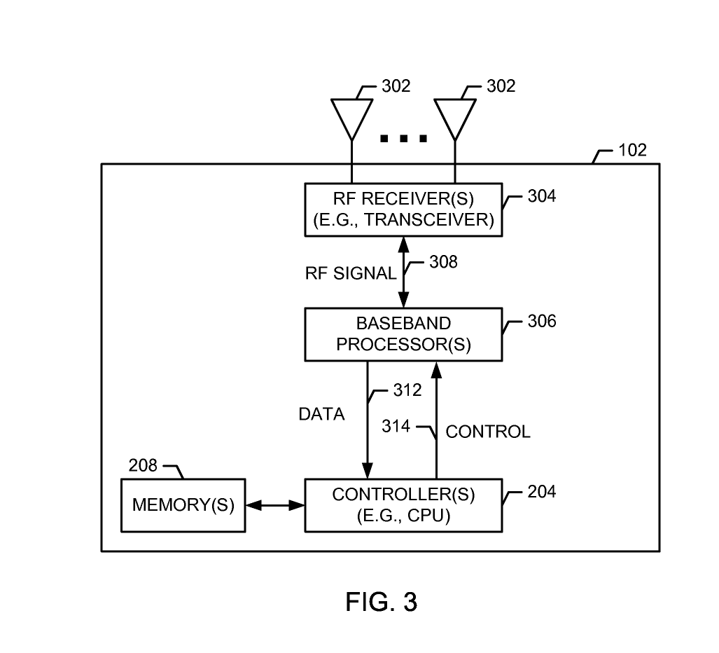

A block diagram of certain elements of an example wireless device 102 for sharing memory between multiple processes of a virtual machine is illustrated in FIG. 3. The wireless device 102 may be implemented in hardware or a combination of hardware and hardware executing software. In one embodiment, the wireless device 102 may include a CPU executing software. Other suitable hardware may include one or more application specific integrated circuits (ASICs), state machines, field programmable gate arrays (FPGAs), and/or digital signal processors (DSPs).

In this example, the wireless device 102 includes a plurality of antennas 302 operatively coupled to one or more radio frequency (RF) receivers 304. The receiver 304 is also operatively coupled to one or more baseband processors 306. The receiver 304 tunes to one or more radio frequencies to receive one or more radio signals 308, which are passed to the baseband processor 306 in a well known manner. The baseband processor 306 is operatively coupled to one or more controllers 310. The baseband processor 306 passes data 312 to the controller 310. A memory 316 operatively coupled to the controller 310 may store the data 312.

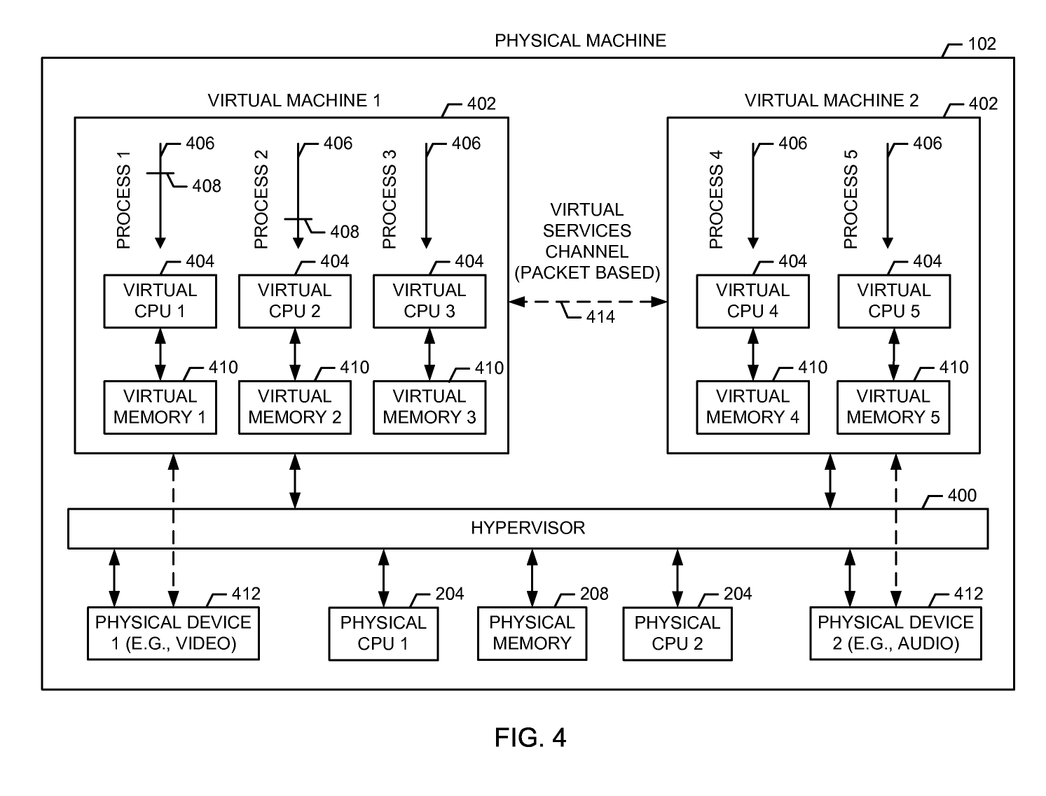

A block diagram of certain elements of yet another example electronic device is illustrated in FIG. 4. In this example, a physical machine 102 includes two physical processors 204. However, any suitable number of physical processors 204 may be included in the physical machine 102. For example, the physical machine 102 may include a multi-core central processing unit with four or more cores. The physical machine 102 also includes one or more physical memories 208 for use by the physical processors 204. For example, the physical machine 102 may include dynamic random access memory (DRAM).

A plurality of virtual machines 402 execute within the physical machine 102. Each virtual machine 402 is a software implementation of a computer and the operating system associated with that computer. Different virtual machines 402 within the same physical machine 102 may use different operating systems. For example, a mobile communication device may include three virtual machines 402 where two of the virtual machines 402 are executing the Android operating system and one of the virtual machines 402 is executing a different Linux operating system.

Each virtual machine 402 includes one or more virtual processors 404 and associated memory resources 410. Each virtual processor 404 executes one or more processes 406 using one or more of the physical processors 204. Similarly, the contents of each virtual memory 410 are stored in the physical memory 208.

A hypervisor 400 controls access by the virtual machines 402 to the physical processors 204, the physical memory 208, and any number of physical devices 412. The physical device 412 may be an input device such as a microphone, an output device such as a speaker, an input/output device such as a touch screen, a coprocessing device (in the same or a different physical machine 102) such as an encryption processor, and/or any other suitable physical device 412. Although a physical device 412 is being shared throughout this description, the present system and method may also be applied to a service (e.g., data encryption) associated with a virtual machine 402 and/or a physical machine 102. In addition, although two virtual machines 402 or two physical machines 102 are sharing a single physical device 412 throughout this description, it will be appreciated that any suitable number of virtual machines 402 and/or physical machines 102 many share any suitable number of physical devices 412 and/or services.

The hypervisor 400 is a software interface between the physical hardware of a computing device, such as a wireless telephone or vehicle user interface system, and multiple operating systems. Each operating system managed by the hypervisor is associated with a different virtual machine, and each operating system appears to have exclusive access to the underlying hardware, such as processors, user interface devices, and memory. However, the hardware is a shared resource, and the hypervisor controls all hardware access (e.g., via prioritized time sharing).

More specifically, the hypervisor 400 schedules each virtual processor 404 to execute on one or more physical processors 204 according to the relative priorities associated with the virtual machines 402. The operating system installed on the virtual machine then schedules a process 406 to execute on the virtual processor 404, and the process 406 typically advances to a progress point 408 unless suspended by the hypervisor 400.

The hypervisor 400 allocates physical memory 208 to each of the virtual processors 404. In some instances, the hypervisor 400 protects one portion of physical memory 208 associated with one process 406 from another portion of physical memory 208 associated with another process 406. In other instances, the hypervisor 400 allows one portion of physical memory 208 associated with one process 406 to be accessed by another virtual processor 404 associated with another process 406. In this manner, the hypervisor 400 facilitates the sharing of memory between multiple processes 406 of a virtual machine 402.

The hypervisor 400 facilitates the sharing of physical device(s) 412 between the virtual machines 402. In some instances, the hypervisor 400 protects one physical device 412 associated with one virtual machine 402 from another virtual machine 402. In other instances, the hypervisor 400 allows one physical device 412 to be accessed by multiple virtual machines 402. As described below, a physical device 412 may be primarily controlled by one virtual machine 402 and accessed by other virtual machines 402 via the primary virtual machine 402 using a packet based virtual services channel 414.

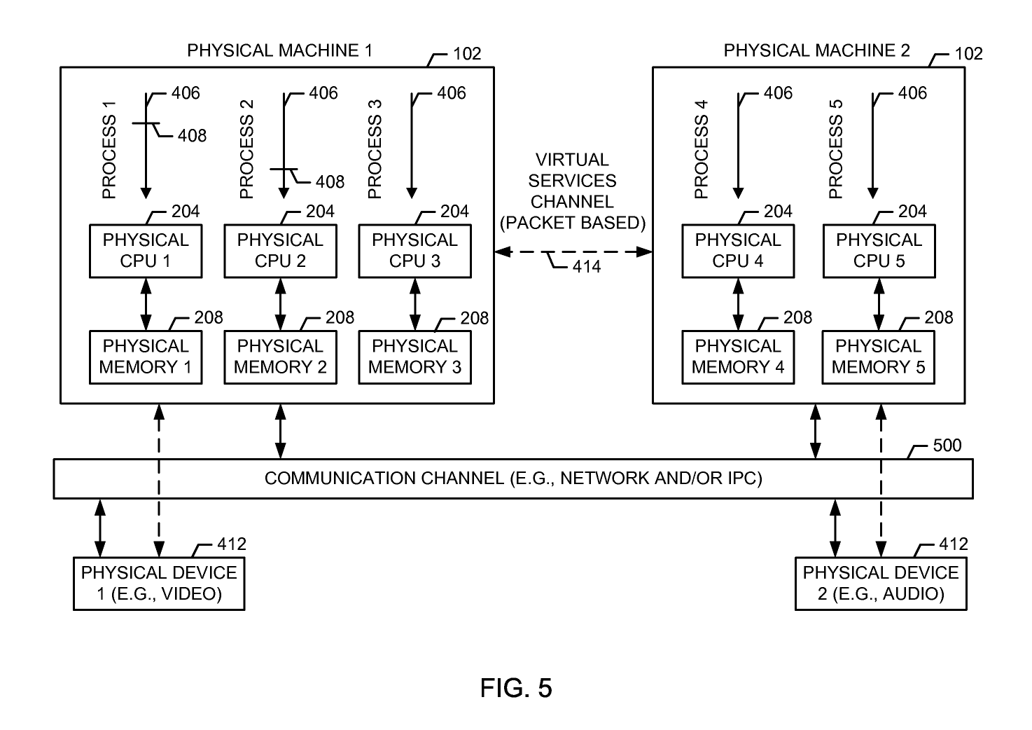

FIG. 5 is a block diagram of two example physical machines 102 connected via a communication channel 500. Each physical machine 102 includes one or more physical processors 204 and associated physical memory 208. Each physical processor 204 executes one or more processes 406 using one or more of the physical processors 204 and one or more of the physical memories 208. As described below, a physical device 412 may be primarily controlled by one physical machine 102 and accessed by other physical machines 102 via the primary physical machine 102 using a packet based virtual services channel 414. The communication channel 500 may be any suitable communication channel such as a wired network, a wireless network, a hypervisor message passing interface, shared memory, a point-to-point physical link (e.g., Ethernet, serial, USB), the Internet, and/or an inter-process communication channel (IPC).

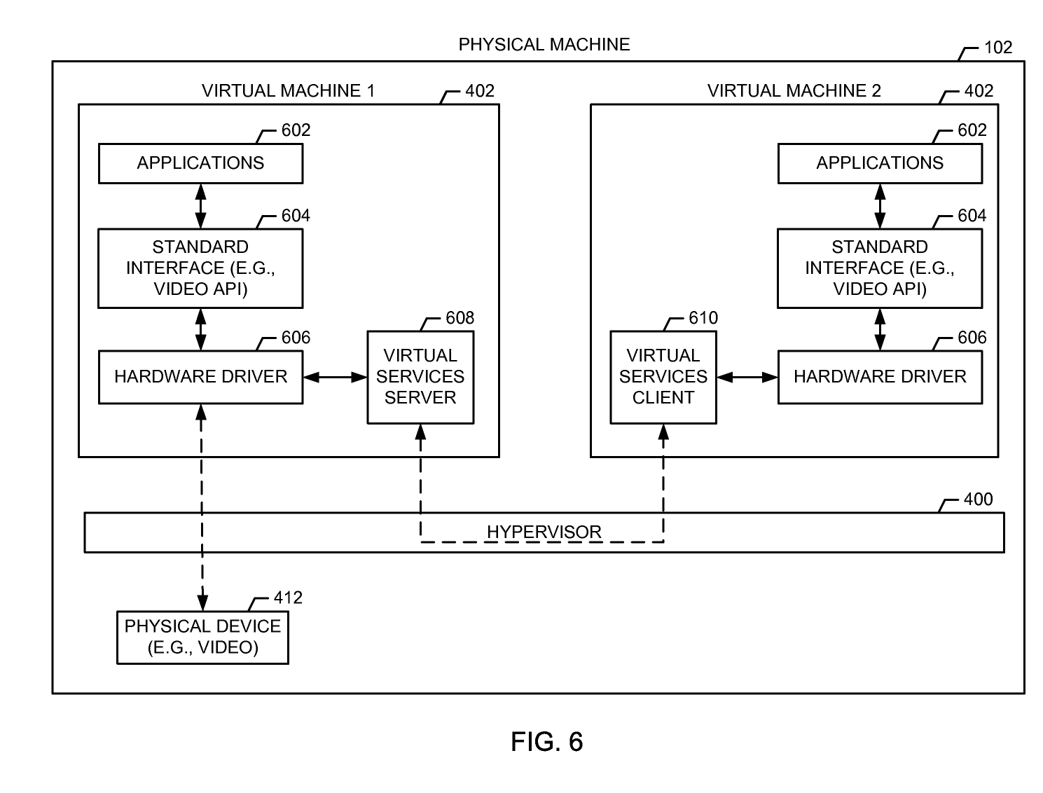

FIG. 6 is another block diagram of the example electronic device illustrated in FIG. 4. In this example, a first virtual machine 402 is running one or more applications 602. For example, the first virtual machine 402 may be running a calendar application. The application 602 in the first virtual machine 402 uses a standard interface 604 to communicate with a hardware driver 606 to access a physical device 412. For example, the calendar application may use a standard video application programming interface (API) to display an appointment on a physical display. In addition, the first virtual machine 402 includes a virtual services server 608. As described below, the virtual services server 608 allows other virtual machines 402 to access the same hardware driver 606.

In this example, a second virtual machine 402 is also running one or more applications 602. For example, the second virtual machine 402 may be running a clock application. The application 602 in the second virtual machine 402 also uses a standard interface 604 to communicate with a hardware driver 606 to access physical devices 412. For example, the clock application may use the standard video application programming interface (API) to display a time on a physical display.

However, in this case, the second virtual machine 402 is not the primary controller of the physical display. Instead, as described in detail below, the hardware driver 606 of the second virtual machine 402 communicates with a virtual services client 610. The virtual services client 610 in turn communicates with the virtual services server 608 of the first virtual machine 402, which communicates with the hardware driver 606 of the first virtual machine 402. The hardware driver 606 of the first virtual machine 402 then communicates with the physical device 412. For example, through this channel, the clock application in the second virtual machine 402 may display the current time on the physical display of the first virtual machine 402.

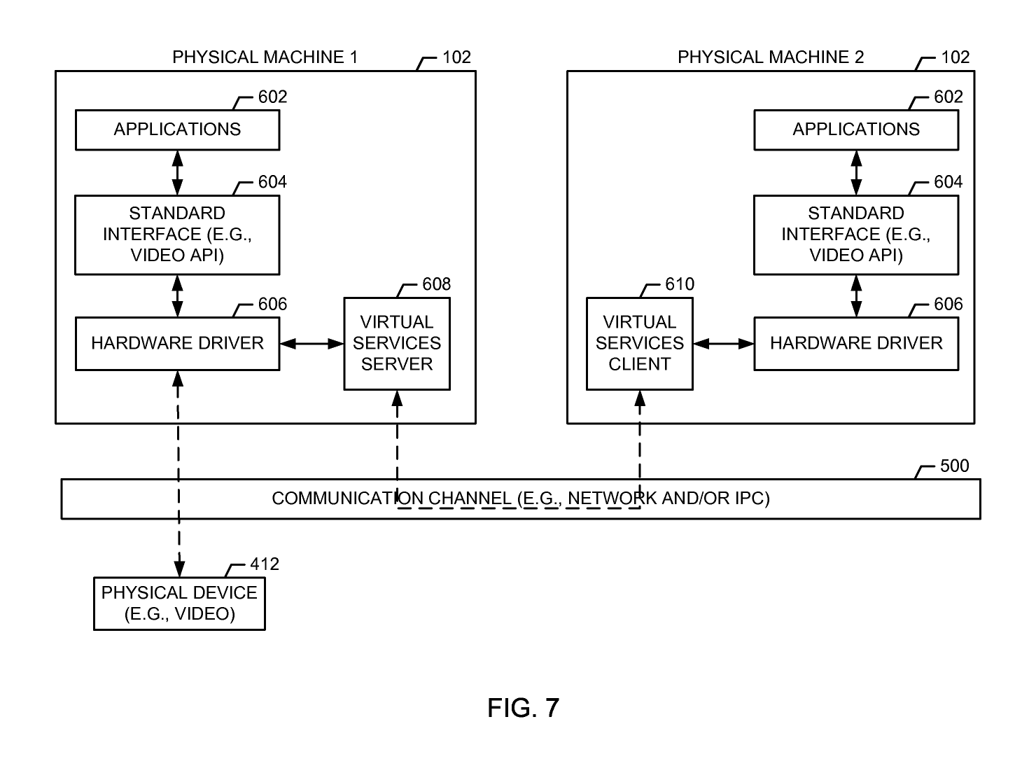

FIG. 7 is another block diagram of the two example physical machines 102 illustrated in FIG. 5. In this example, a first physical machine 102 is running one or more applications 602. For example, the first physical machine 102 may be running a calendar application. The application 602 in the first physical machine 102 uses a standard interface 604 to communicate with a hardware driver 606 to access a physical device 412. For example, the calendar application may use a standard video application programming interface (API) to display an appointment on a physical display. In addition, the first physical machine 102 includes a virtual services server 608. As described below, the virtual services server 608 allows other physical machines 102 to access the same hardware driver 606.

In this example, a second physical machine 102 is also running one or more applications 602. For example, the second physical machine 102 may be running a clock application. The application 602 in the second physical machine 102 also uses a standard interface 604 to communicate with a hardware driver 606 to access physical devices 412. For example, the clock application may use the standard video application programming interface (API) to display a time on a physical display.

However, in this case, the second physical machine 102 is not the primary controller of the physical display. Instead, as described in detail below, the hardware driver 606 of the second physical machine 102 communicates with a virtual services client 610. The virtual services client 610 in turn communicates with the virtual services server 608 of the first physical machine 102, which communicates with the hardware driver 606 of the first physical machine 102. The hardware driver 606 of the first physical machine 102 then communicates with the physical device 412. For example, through this channel, the clock application in the second physical machine 102 may display the current time on the physical display of the first physical machine 102.

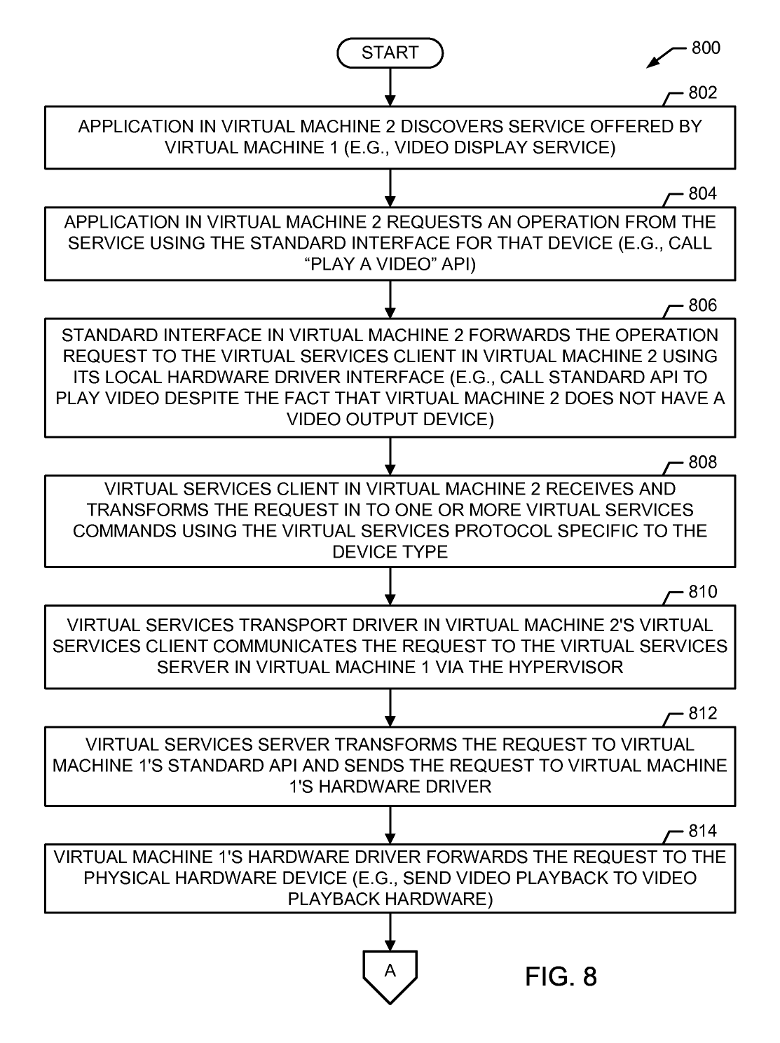

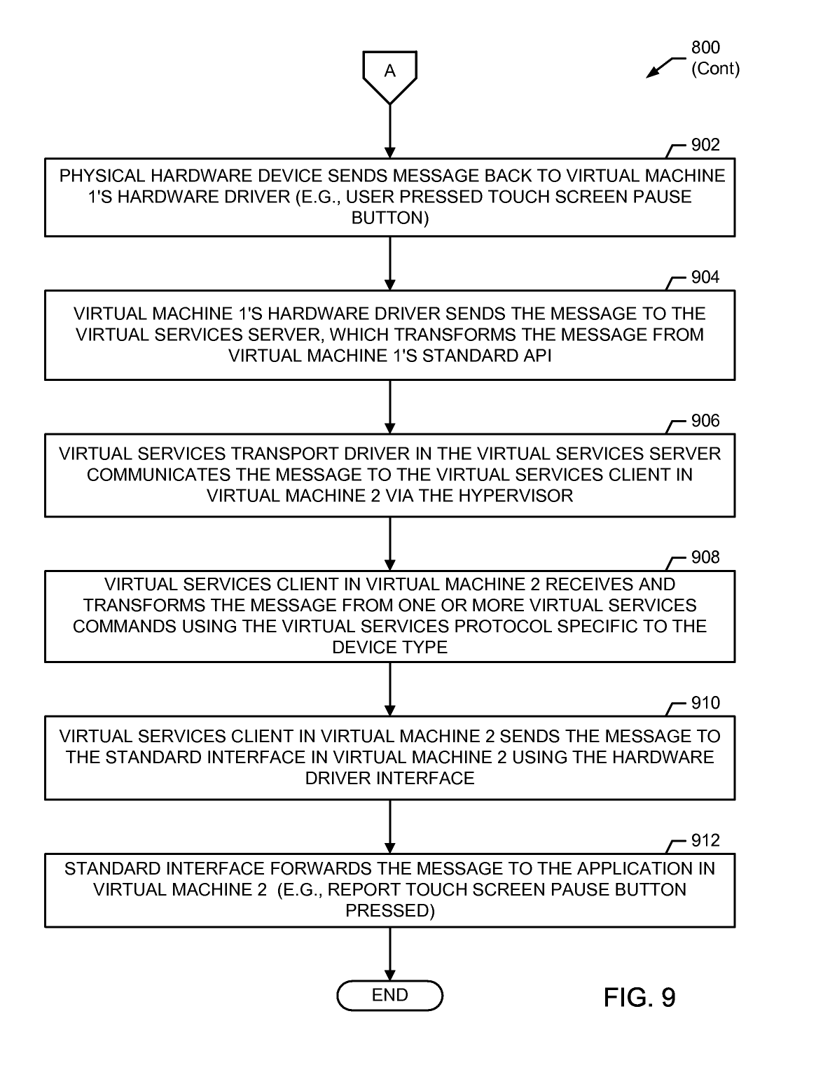

FIGS. 8-9 are a flowchart of an example process 800 for sharing a physical device between multiple virtual machines. The process 800 may be carried out by one or more suitably programmed processors such as a CPU executing software (e.g., block 204 of FIG. 2). The process 800 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 800 is described with reference to the flowchart illustrated in FIGS. 8-9, it will be appreciated that many other methods of performing the acts associated with process 800 may be used. For example, the order of many of the operations may be changed, and some of the operations described may be optional.

The example process 800 begins when an application 602 in the second virtual machine 402 discovers a service offered by the first virtual machine 402 (block 802). For example, the first virtual machine 402 may offer a video display service. The application 602 in the second virtual machine 402 then requests an operation from the service using the standard interface 604 for that device (block 804). For example, the second virtual machine 402 may call “play a video” API. The standard interface 604 in second virtual machine 402 then forwards the operation request to the virtual services client 610 in the second virtual machine 402 using its local hardware driver interface 606 (block 806). For example, the second virtual machine 402 may call a standard API to play video despite the fact that the second virtual machine 402 does not have a video output device.

The virtual services client 610 in the second virtual machine 402 then receives and transforms the request in to one or more virtual services commands using the virtual services protocol specific to the device type (block 808), and the virtual services transport driver in the virtual services client 610 of the second virtual machine 402 communicates the request to the virtual services server 608 in the first virtual machine 402 via the hypervisor 400 (block 810). The virtual services server 608 then transforms the request to the standard API for the first virtual machine 402 and sends the request to the first virtual machine's hardware driver 606 (block 812). The first virtual machine's hardware driver 606 then forwards the request to the physical hardware device 412 (block 814). For example, the first virtual machine's hardware driver 606 may send video data to video playback hardware.

The physical hardware device 412 may also send a message back to the first virtual machine's hardware driver 606 (block 902). For example, the physical hardware device 412 may indicate that a user pressed a touch screen “pause” button during the video playback. In such an instance, the first virtual machine's hardware driver 606 sends the message to the virtual services server 608, which transforms the message from the standard API for the first virtual machine 402 (block 904). The virtual services transport driver in the virtual services server 608 then communicates the message to the virtual services client 610 in the second virtual machine 402 via the hypervisor 400 (block 906).

The virtual services client 610 in the second virtual machine 402 then receives and transforms the message from one or more virtual services commands using the virtual services protocol specific to the device type (block 908). The virtual services client 610 in second virtual machine 402 then sends the message to the standard interface 604 in the second virtual machine 402 using the hardware driver interface 606 of the second virtual machine 402 (block 910). The standard interface 604 of the second virtual machine 402 then forwards the message to the application 602 in the second virtual machine 402 (block 912). For example, the standard interface 604 may report that a touch screen “pause” button was pressed.

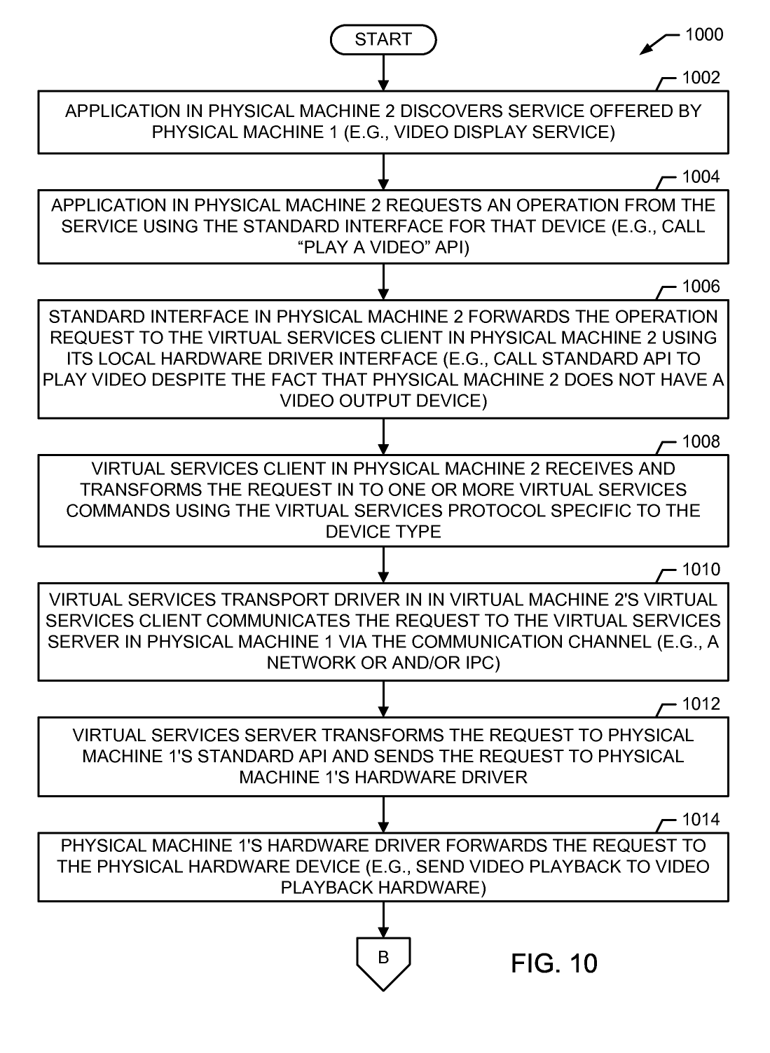

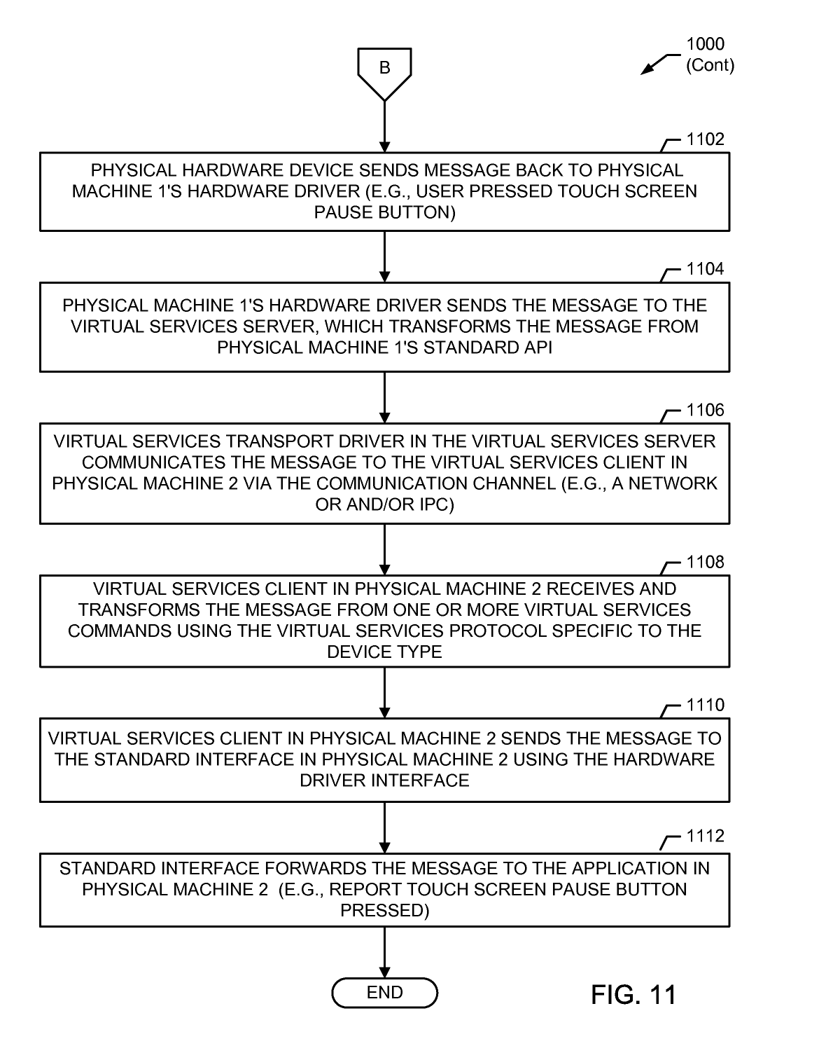

FIGS. 10-11 are a flowchart of an example process for sharing a physical device between multiple physical machines. The process 1000 may be carried out by one or more suitably programmed processors such as a CPU executing software (e.g., block 204 of FIG. 2). The process 1000 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 1000 is described with reference to the flowchart illustrated in FIGS. 10-11, it will be appreciated that many other methods of performing the acts associated with process 1000 may be used. For example, the order of many of the operations may be changed, and some of the operations described may be optional.

More specifically, the example process 1000 begins when an application 602 in the second physical machine 102 discovers a service offered by the first physical machine 102 (block 1002). For example, the first physical machine 102 may offer a video display service. The application 602 in the second physical machine 102 then requests an operation from the service using the standard interface 604 for that device (block 1004). For example, the second physical machine 102 may call “play a video” API. The standard interface 604 in second physical machine 102 then forwards the operation request to the virtual services client 610 in the second physical machine 102 using its local hardware driver interface 606 (block 1006). For example, the second physical machine 102 may call a standard API to play video despite the fact that the second physical machine 102 does not have a video output device.

The virtual services client 610 in the second physical machine 102 then receives and transforms the request in to one or more virtual services commands using the virtual services protocol specific to the device type (block 1008), and the virtual services transport driver in the virtual services client 610 of the second virtual machine 402 communicates the request to the virtual services server 608 in the first physical machine 102 via a communication channel 500 (block 1010). The communication channel 500 may be any suitable communication channel such as a wired network, a wireless network, a hypervisor message passing interface, shared memory, a point-to-point physical link (e.g., Ethernet, serial, USB), the Internet, and/or an inter-process communication channel (IPC).

The virtual services server 608 then transforms the request to the standard API for the first physical machine 102 and sends the request to the first physical machine's hardware driver 606 (block 1012). The first physical machine's hardware driver 606 then forwards the request to the physical hardware device 412 (block 1014). For example, the first physical machine's hardware driver 606 may send video data to video playback hardware.

The physical hardware device 412 may also send a message back to the first physical machine's hardware driver 606 (block 1102). For example, the physical hardware device 412 may indicate that a user pressed a touch screen “pause” button during the video playback. In such an instance, the first physical machine's hardware driver 606 sends the message to the virtual services server 608, which transforms the message from the standard API for the first physical machine 102 (block 1104). The virtual services transport driver in the virtual services server 608 then communicates the message to the virtual services client 610 in the second physical machine 102 via the communication channel 500 (block 1106).

The virtual services client 610 in the second physical machine 102 then receives and transforms the message from one or more virtual services commands using the virtual services protocol specific to the device type (block 1108). The virtual services client 610 in second physical machine 102 then sends the message to the standard interface 604 in the second physical machine 102 using the hardware driver interface 606 of the second physical machine 102 (block 1110). The standard interface 604 of the second physical machine 102 then forwards the message to the application 602 in the second physical machine 102 (block 1112). For example, the standard interface 604 may report that a touch screen “pause” button was pressed.

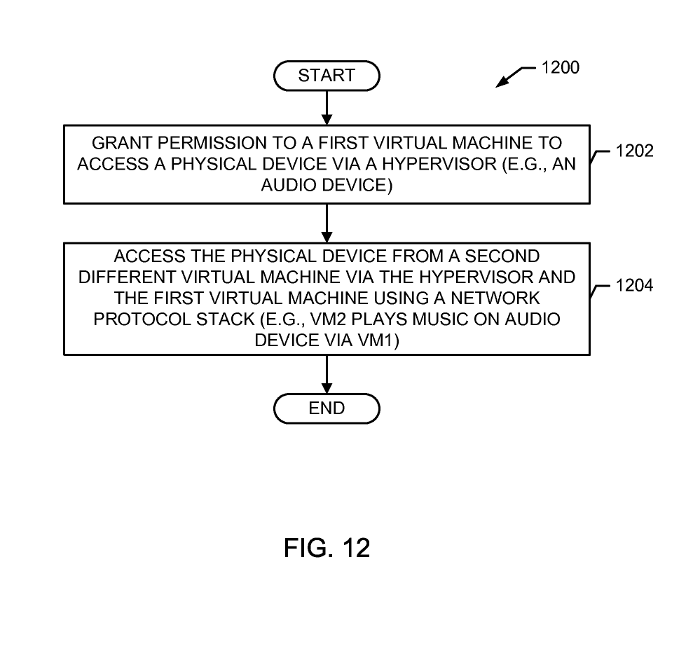

FIG. 12 is a flowchart of another example process for sharing a physical device between multiple virtual machines. The process 1200 may be carried out by one or more suitably programmed processors such as a CPU executing software (e.g., block 204 of FIG. 2). The process 1200 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 1200 is described with reference to the flowchart illustrated in FIGS. 10-11, it will be appreciated that many other methods of performing the acts associated with process 1200 may be used. For example, the order of many of the operations may be changed, and some of the operations described may be optional.

The example process 1200 begins when a hypervisor 400 grants permission to a first virtual machine 402 to access a physical device 412 via the hypervisor 400 (block 1202). For example, the hypervisor 400 may grant permission to a first virtual machine 402 to access a physical audio device. A second virtual machine 402 then accesses the physical device 412 via the hypervisor 400 and the first virtual machine 402 using a virtual services network stack 1400 (block 1204). For example, the second virtual machine 402 may play music on the audio device via the first virtual machine 402.

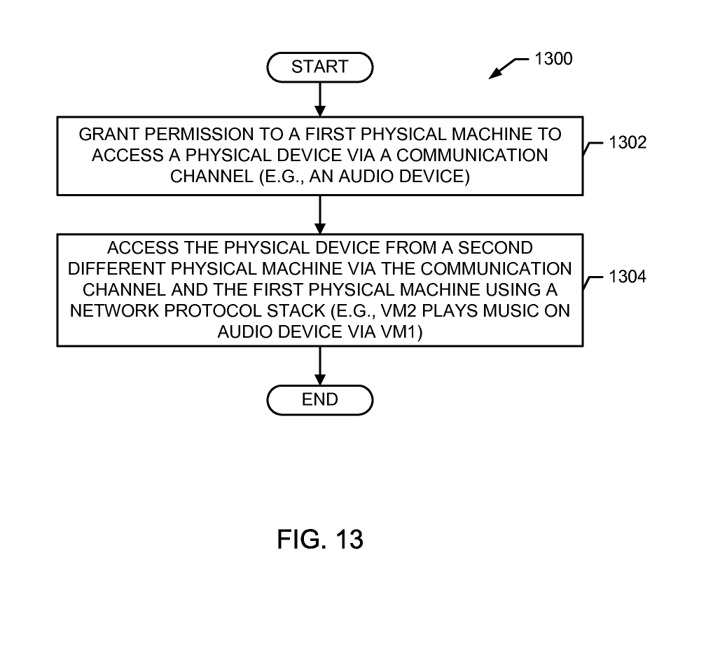

FIG. 13 is a flowchart of another example process for sharing a physical device between multiple physical machines. The process 1300 may be carried out by one or more suitably programmed processors such as a CPU executing software (e.g., block 204 of FIG. 2). The process 1300 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 1300 is described with reference to the flowchart illustrated in FIGS. 10-11, it will be appreciated that many other methods of performing the acts associated with process 1300 may be used. For example, the order of many of the operations may be changed, and some of the operations described may be optional.

The example process 1300 begins when a first physical machine 102 is granted permission to access and/or is connected to a physical device 412 via a communication channel 500 (block 1302). For example, the physical device 412 may be an audio device. A second physical machine 102 then accesses the physical device 412 via the communication channel 500 and the first physical machine 102 using a virtual services network stack 1400 (block 1304). For example, the second physical machine 102 may play music on the audio device via the first physical machine 102.

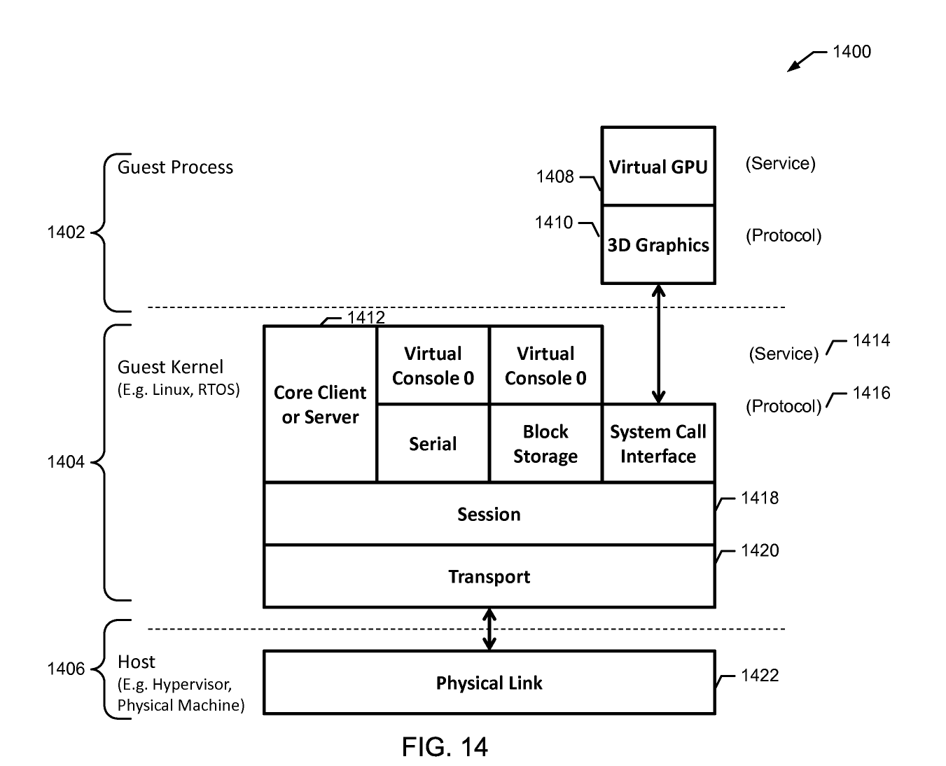

FIG. 14 is an example virtual service network stack 1400 showing one end of a virtual services session with one core service and three other services. In this example, the virtual service network stack 1400 is a packet switched protocol stack including a guest process 1402, a guest kernel 1404, and a host 1406. For example, the guest kernel 1404 may be Linux, any suitable real-time operating system (RTOS), a stand-alone application with no kernel, etc., and the host 1406 may be a microvisor, a hypervisor, hardware, etc. In this example, the guest process 1402 includes a service layer 1408 and a protocol layer 1410. The example guest kernel 1404 includes a core client or server 1412, a service layer 1414, a protocol layer 1416, a session layer 1418, and a transport layer 1420. The example host 1406 includes a physical link layer 1422.

The host 1406 provides the physical communication link 1422, which may be supported by a fixed allocation of physical memory 208 (or some other finite resource). In this case, the link 1422 may be able to store only a limited number of packet buffers, each of limited size, containing messages in transit between virtual machines 402 or physical machines 102. The session layer 1418 and transport layer 1420 may support multiple virtual service servers 608 and/or virtual service clients 610 over this single link, typically by using packet-switched multiplexing.

The session layer 1418 supports multiple services 1414 and 1408 on a single physical link 1422. The set of services that are present may be fixed when the system is constructed; alternatively, they may vary during the operation of the system. Services may be added or removed as the system configuration changes; for example, when attaching a removable hardware device, or connecting to a network service.

The virtual services server 608 may notify the virtual services client 610 of the addition or removal of services using its session management service 1412, which is integrated with the session layer 1418 and is typically always present, but otherwise functions as a virtual service itself. The notification of a new service's presence may include information that the client 610 uses to decide whether and how to make use of the service, including the name of the service, its resource quotas, and the communication protocol it uses.

During the operation of a shared physical device 412 or virtual service, it is sometimes necessary to reset the device 412 or service, thereby forcing the device 412 or service to return to an initial state. It may also be necessary to temporarily make a device 412 or service unavailable to a client 610 after resetting the device 412 or service. For example, this may form part of an attempt to recover from a failure in the underlying physical device 412 or in the server 608 or client software 610. It may also occur as part of an access policy decision, removing access to a service from a client 610 that is not currently allowed to use it, or disabling a service that is failing repeatedly or is about to be removed.

The session layer 1418 may maintain a readiness state machine for each shared physical device 412 or virtual service, such that the device 412 or service is able to communicate only when the session layers 1418 of the client 610 and server 608 agree that communication should be allowed. The session layers 1418 may signal each other via the session management service or the transport layer 1420 in order to coordinate their readiness state machines.

A similar reset mechanism may be integrated in to the transport layer 1420 to deal with failures in the transport layer 1420 or session layer 1418 or the session management service. This mechanism has the same purpose as the session layer's reset mechanism, but uses a signaling mechanism provided by the physical link 1422, and resets and temporarily disables communication for all devices 412 and services using the physical link 1422, including the session layer 1418 and session management service.

To prevent any devices 412 or service from consuming too many of the physical link 1422 or transport layer 1420's finite resources either maliciously or inadvertently, and thus impeding communication by other devices 412 and services, the transport layer 1420 may limit each device 412 or service's consumption of resources. For example, a device 412 or service may be limited to using a certain number of packet buffers to transfer packets to its remote counterpart at any given time. When a device 412 or service is connected or created, it may be allocated a fixed quota of each finite transport resource. The session layer 1418 may inform its own remote counterpart of the quotas, to assist in enforcement.

Some finite resources, including packet buffers, are typically allocated at one end of the link and then released at the other end of the link. In order to enforce quotas for such resources, the transport layer 1420 may signal to its remote counterpart when a client 610 or server 608 releases a resource that has been allocated by that client or server's remote counterpart. This signaling may be piggy-backed on a message sent by the client 610 or server 608. Alternatively, the signaling may take the form of an independent message sent over the physical link 1422 automatically by the transport layer 1420.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of sharing access to a service between a plurality of physical machines, the method comprising:
granting permission to a first physical machine to access the service via a communication channel; and
using a packet switched protocol stack to access the service from a second different physical machine via the communication channel and the first physical machine.

2. The method of claim 1, further comprising using the packet switched protocol stack to access a physical device from the second virtual machine via the hypervisor and the first virtual machine.

3. The method of claim 1, wherein the service is an encryption service.

4. The method of claim 1, wherein the service is performed by a coprocessor.

5. The method of claim 1, wherein granting permission to the first virtual machine to access the service includes granting permission to the first virtual machine to access physical memory associated with the service.

6. An apparatus for sharing access to a service between a plurality of physical machines, the apparatus comprising:
a communication channel; and
at least one physical processor operatively coupled to the communication channel; wherein the at least one physical processor is structured to:
grant permission to a first physical machine to access the service via the communication channel; and
use a packet switched protocol stack to facilitate accessing the service from a second different physical machine via the communication channel and the first physical machine.

7. The apparatus of claim 6, wherein the apparatus also uses the packet switched protocol stack to access a physical device from the second virtual machine via the hypervisor and the first virtual machine.

8. The apparatus of claim 6, wherein the service is an encryption service.

9. The apparatus of claim 6, wherein the service is performed by a coprocessor.

10. The apparatus of claim 6, wherein granting permission to the first virtual machine to access the service includes granting permission to the first virtual machine to access physical memory associated with the service.

11. A computer readable memory storing instructions structured to cause an electronic device to:
grant permission to a first physical machine to access a service via a communication channel; and
use a packet switched protocol stack to access the service from a second different physical machine via the communication channel and the first physical machine.

12. The computer readable memory of claim 11, wherein the electronic device also uses the packet switched protocol stack to access a physical device from the second virtual machine via the hypervisor and the first virtual machine.

13. The computer readable memory of claim 11, wherein the service is an encryption service.

14. The computer readable memory of claim 11, wherein the service is performed by a coprocessor.

15. The computer readable memory of claim 11, wherein granting permission to the first virtual machine to access the service includes granting permission to the first virtual machine to access physical memory associated with the service.
